(19) United States
(12) Patent Application Publication
(10) Pub. No.: US 2014/0257951 A1
(43) Pub. Date: Sep. 11, 2014

(54) METHODS AND SYSTEMS FOR REMUNERATING CROWDWORKERS

(71) Applicant: XEROX CORPORATION, Norwalk, CT (US)

(72) Inventors: Laura E Celis, Bangalore (IN); Shourya Roy, Bangalore (IN)

(73) Assignee: XEROX CORPORATION, Norwalk, CT (US)

(21) Appl. No.: 13/787,873

(22) Filed: Mar. 7, 2013

(51) Int. Cl. G06Q 30/02

(52) U.S. Cl. CPC G06Q 30/0208
USPC 705/14.11

(57) ABSTRACT

According to embodiments illustrated herein there is provided methods and systems implementable on a computing device for remunerating one or more crowdworkers. The method comprising allotting at least one crowdworker from the one or more crowdworkers with a first lottery ticket from a set of lottery tickets on completion of a task allocated to the at least one crowdworker. One or more lottery tickets from the set of lottery tickets are selected by utilizing one or more techniques. Winnings are remunerated to each of a set of crowdworkers from the one or more crowdworkers associated with the one or more selected lottery tickets.

### TECHNICAL FIELD

The presently disclosed embodiments are related, in general, to crowdsourcing. More particularly, the presently disclosed embodiments are related to systems and methods for remunerating crowdworkers.

### BACKGROUND

Crowdsourcing platforms enable a plurality of crowdworkers to contribute to complete a task. The plurality of crowdworkers may get a compensation for their respective contributions. One or more requestors publish one or more tasks on the crowdsourcing platforms. The crowdsourcing platforms may distribute the one or more tasks to the plurality of crowdworkers associated with the crowdsourcing platforms. The plurality of crowdworkers completes the one or more tasks and submits a final work product to the crowdsourcing platforms. The crowdsourcing platforms may validate the final work product for quality checks. Accordingly, the crowdsourcing platforms may compensate the plurality of crowdworkers. The crowdsourcing platforms may compensate the plurality of crowdworkers using one or more paying models such as, but are not limited to, pay-per-task (i.e., a crowdworker is paid for each completed job), pay-per-hour (i.e., the crowdworker is paid for hours spent on the task), and contest.

As the plurality of crowdworkers is not legally bound to complete the one or more tasks, the crowdsourcing platforms may not be able to ensure whether the one or more tasks allocated to the plurality of crowdworkers is completed. Thus, in order to get the task done, the crowdsourcing platforms may need to give incentives to lure the crowdworkers to complete the plurality of tasks.

### SUMMARY

According to embodiments illustrated herein there is provided a method implementable on a computing device for remunerating one or more crowdworkers. The method comprising allotting at least one crowdworker from the one or more crowdworkers with a first lottery ticket from a set of lottery tickets on completion of a task allocated to the at least one crowdworker. One or more lottery tickets from the set of lottery tickets are selected by utilizing one or more techniques. Winnings are remunerated to each of a set of crowdworkers from the one or more crowdworkers associated with the one or more selected lottery tickets.

According to embodiment illustrated herein there is provided a crowdsourcing server for remunerating one or more crowdworkers. The crowdsourcing server includes a lottery distribution manager configured to allot at least one crowdworker from the one or more crowdworkers with a first lottery ticket from a set of lottery tickets on completion of a task allocated to the at least one crowdworker. A lottery selection module configured to select one or more lottery tickets from the set of lottery tickets by utilizing one or more techniques. A remuneration manager configured to remunerate winnings to each of a set of crowdworkers from the one or more crowdworkers associated with the one or more selected lottery tickets.

According to embodiment illustrated herein there is provided a computer program product for remunerating one or more crowdworkers. The computer program product includes a set of instructions executable by a processor. The set of instructions includes a program instruction means for allotting at least one crowdworker from the one or more crowdworkers with at least one of a first lottery ticket from a set of lottery tickets on completion of a task allocated to the at least one crowdworker. The set of instructions further includes a program instruction means for selecting one or more lottery tickets from the set of lottery tickets by utilizing one or more techniques. Additionally, the set of instructions further include a program instruction means for remunerating winnings to each of a set of crowdworkers from the one or more crowdworkers associated with the one or more selected lottery tickets.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit, the scope in any manner, wherein like designations denote similar elements, and in which:

FIG. 1 is a block diagram of a system environment in which various embodiments can be implemented;

FIG. 2 is a block diagram of a system for remunerating a crowdworker, in accordance with at least one embodiment;

FIG. 3 is a flowchart illustrating a method for remunerating a crowdworker, in accordance with at least one embodiment; and

FIG. 4 is an example API displayed to the crowdworker, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “at least one embodiment”, “an embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “task” refers to a piece of work, an activity, an action, a job, an instruction or an assignment to be performed. Tasks may necessitate the involvement of one or more crowdworkers. Examples of tasks include, but are not limited to, generating a report, evaluating a document, conducting a survey, writing a code, extraction of data, translating a text, and the like.

“Crowdsourcing” refers to distributing tasks by soliciting the participation of loosely defined groups of individual crowdworkers. A group of crowdworkers may include, for example, individuals responding to a solicitation posted on a certain website such as, but is not limited to, Amazon Mechanical Turk and Crowd Flower.

A “crowdsourcing platform” refers to a business application that is defined as an external group of people, community, or organization that provides solutions as an output for any specific business processes received by the application as an input. In an embodiment, the business application can be hosted online on a web portal (e.g., a crowdsourcing platform server). Various examples of the crowdsourcing platforms include, but are not limited to, Amazon Mechanical Turk or Crowd Flower.

A “crowdworker” refers to a workforce/worker(s) that may perform one or more tasks, which generate data that contributes to a defined result such as proofreading a part of a digital version of an ancient text or analyzing a quantum of a large volume of data. According to the present disclosure, the remote worker(s) includes, but is not limited to, a satellite center employee, a rural business process outsourcing BPO firm employee, a home-based employee, or an internet-based employee. Hereinafter, “crowdworker”, “worker”, “remote worker” “crowdsourced workforce”, “crowdworker”, and “crowd” may be interchangeably used.

A “lottery ticket” refers to a form of identification (ID) that may correspond to at least one of a number, word, or phrase. In an embodiment, the IDs are unique. In an embodiment, an ID is generated randomly. In an alternate embodiment the ID is generated deterministically, e.g., sequential order of completion of the tasks. In an embodiment, the worker may choose their own ID, e.g., crowdworker may choose to use their respective lucky number as the ID. In an embodiment, the ID is allotted to the crowdworker on the completion of a task. In an embodiment, the crowdworker may buy the ID using the pay remunerated to him for completing the task. The crowdworker selects a priori whether they prefer lottery tickets (i.e., unique ID) or pay for completion of a task. In an embodiment, the ID may be printable on a piece of paper. In an alternate embodiment, the ID is a virtual tag that is allotted to the crowdworker. For example, on the completion of the task, the crowdworker may receive an email including a task completion ID. In an embodiment, the task completion ID may act as the unique ID for the crowdworker. Similarly, some examples of lottery ticket may include, but are not limited to, task ID, task completion ID, a tag with a unique ID, a token with a unique ID, a printed paper having a unique ID, or any other tag having a unique ID.

“Remunerate” refers to a payment bestowed to a crowdworker as winnings of a lottery. In an embodiment, winnings of the lottery may include, but are not limited to, a predetermined amount of money, a predetermined amount of credit points, an opportunity to participate in next lottery, a set of lottery tickets for the next lottery, predefined goods/prizes, and the like.

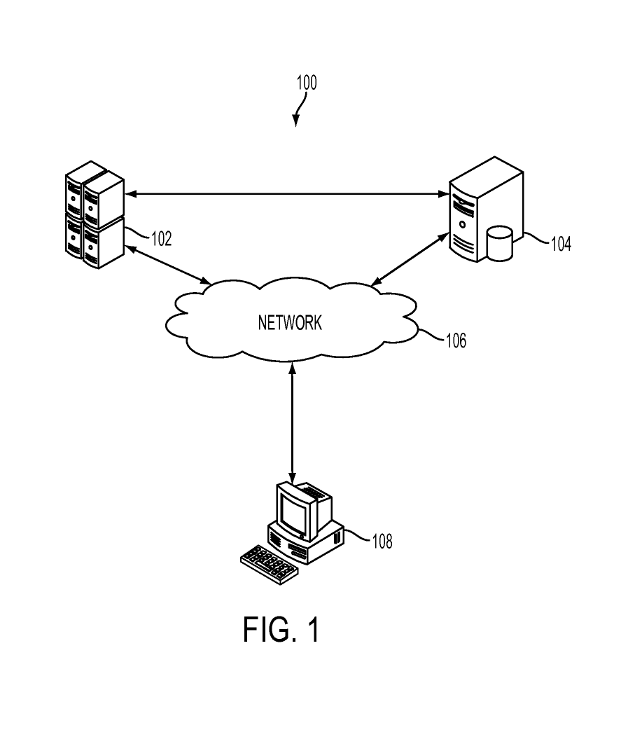

FIG. 1 is a block diagram of a system environment 100 in which various embodiments can be implemented. The system environment 100 includes a crowdsourcing platform server 102, a database server 104, a network 106, and a computing device 108.

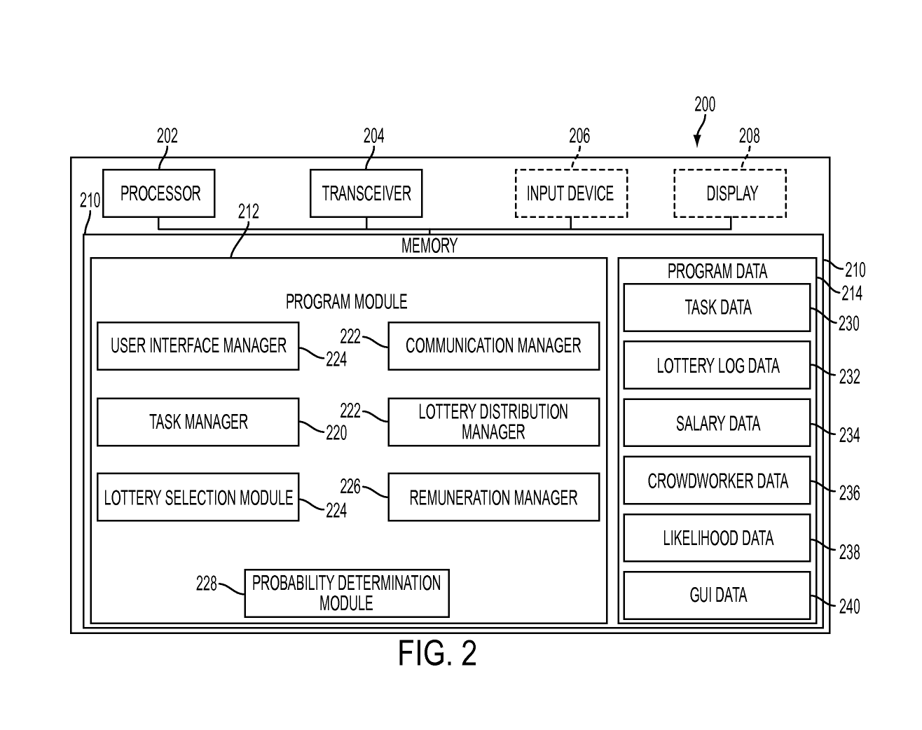

The crowdsourcing platform server 102 is configured to host one or more crowdsourcing platforms. A crowdsourcing platform is configured to manage one or more crowdworkers. The crowdsourcing platform registers the one or more crowdworkers. Further, the crowdsourcing platform allocates one or more tasks to the one or more crowdworkers. In an embodiment, the crowdsourcing platform presents an application interface (API) to the one or more crowdworkers through the computing device 108. The one or more crowdworkers may access the allocated one or more tasks through the API. Further, the one or more crowdworkers may submit a final work product to the crowdsourcing platform through the API. The crowdsourcing platform validates the final work product for quality checks. Thereafter, the crowdsourcing platform allots a lottery ticket from a set of lottery tickets to at least one crowdworker for the final work product as remuneration. The crowdsourcing platform selects one or more lottery tickets from the set of lottery tickets as the winning tickets. The crowdsourcing platform remunerates winnings (winning amount) to a set of crowdworkers associated with the winning tickets. In an alternate embodiment, the crowdsourcing platform remunerates a pay to the at least one crowdworker for the final work product. The crowdsourcing platform is described in detail in conjunction with FIG. 2. In an embodiment, the crowdsourcing platform server 102 may be realized through an application server such as but not limited to, Java application server, .NET framework, and Base4 application server.

The database server 104 is configured to store information associated with the one or more crowdworkers. Further, the database server 104 maintains a log of the set of lottery tickets. In an embodiment, the log includes information related to the one or more lottery tickets allotted to the one or more crowdworkers. In an embodiment, the database server 104 may receive a query from the crowdsourcing platform server 102 to extract the log and the information associated with the one or more crowdworkers. The database server 104 may be realized through various technologies, such as, but not limited to, Microsoft® SQL server, Oracle, and My SQL. In an embodiment, the crowdsourcing platform server 102 may connect to the database server 104 using one or more protocols such as, but not limited to, ODBC protocol and JDBC protocol.

A person having ordinary skills in the art would understand that the scope of the disclosure is not limited to the database server 104 as a separate entity. In an embodiment, the database server 104 can be integrated in the crowdsourcing server 102.

The network 106 corresponds to a medium through which content and messages flow between various devices of the system environment 100 (e.g. the computing device 108, database server 104, and the crowdsourcing platform server 102). Examples of the network 106 may include, but are not limited to, a Wireless Fidelity (Wi-Fi) network, a Wireless Area Network (WAN), a Local Area Network (LAN) or a Metropolitan Area Network (MAN). Various devices in the system environment 100 can connect to the network 106 in accordance with the various wired and wireless communication protocols such as Transmission Control Protocol and Internet Protocol (TCP/IP), User Datagram Protocol (UDP), and 2G, 3G, or 4G communication protocols.

The computing device 108 presents the API to a crowdworker. In an embodiment, the API is a web interface facilitated by the crowdsourcing platform. The crowdworker receives a task from the crowdsourcing platform through the API. Further, the crowdworker submits the final work product through the API on the computing device 108. Some of the examples of the computing device 108 include a personal computer, a laptop, a PDA, a mobile device, a tablet, or any device that has the capability to display the API to the crowdworker.

FIG. 2 is a block diagram of a system 200 for remunerating a crowdworker, in accordance with at least one embodiment. The system 200 is described in conjunction with FIG. 1.

The system 200 includes a processor 202, a transceiver 204, and a memory 210. In an embodiment, the system 200 may correspond to the computing device 108 or the crowdsourcing platform server 102. In a scenario where the system 200 corresponds to the computing device 108, the system 200 includes an input device 206 and a display 208. For the purpose of ongoing description, the system 200 is considered as the crowdsourcing platform server 102. However, the scope of the disclosure should not be limited to the system 200 as the crowdsourcing platform server 102. The system 200 can also be realized as the computing device 108.

The processor 202 is coupled to the transceiver 204, the input device 206, the display 208 and the memory 210. The processor 202 executes a set of instructions stored in the memory 210 to perform a predetermined operation on the system 200. The processor 202 can be realized through a number of processor technologies known in the art. Examples of the processor 202 may include, but are not limited to, X86 processor, RISC processor, ASIC processor, CISC processor, ARM processor, or any other processor.

The transceiver 204 transmits and receives messages and data to/from various components of the system environment 100 (e.g., the computing device 108 and the database server 104). Examples of the transceiver 204 may include, but are not limited to, an antenna, an Ethernet port, a USB port or any other port that can be configured to receive and transmit data. The transceiver 204 transmits and receives data/messages in accordance with the various communication protocols, such as, TCP/IP, UDP, and 2G, 3G, or 4G communication protocols.

In an embodiment, the input device 206 receives an input from a user of the system 200. In an embodiment, a user input may be intended for accessing the task received from the crowdsourcing platform. Further, the user input may be intended for submission of the final work product to the crowdsourcing platform. Examples of the input device 206 include, but are not limited to, a mouse, a keyboard, a touch panel, a track-pad, a touch screen, or any other device that has the capability of receiving the user input.

In an embodiment, the display 208 displays the API to a user of the system 200. The display 208 can be realized through several known technologies, such as, a Cathode Ray Tube (CRT) based display, a Liquid Crystal Display (LCD), a Light Emitting Diode (LED)-based display, an Organic LED display technology, and a Retina Display technology. Further, the display 208 can be a touch screen that receives the user input.

The memory 210 stores a set of instructions and data. Some of the commonly known memory implementations include, but are not limited to, a random access memory (RAM), a read only memory (ROM), a hard disk drive (HDD), and a secure digital (SD) card. Further, the memory 210 includes a program module 212 and a program data 214. The program module 212 includes a set of instructions that is executable by the processor 202 to perform specific operations. The program module 212 further includes a user interface manager 216, a communication manager 218, a task manager 220, a lottery distribution manager 222, a lottery selection module 224, a remuneration manager 226, and a probability determination module 228. It is apparent to a person having ordinary skills in the art that the set of instructions stored in the memory 210 enables the hardware of the system 200 to perform the predetermined operation.

The program data 214 includes a task data 230, a lottery log data 232, a salary data 234, a crowdworker data 236, a probability data 238, and a GUI data 240.

A person skilled in the art would understand that the scope of the disclosure should not be limited to the program data 214 comprising the task data 230, the lottery log data 232, the salary data 234, the crowdworker data 236, the probability data 238, and the GUI data 240. In an embodiment, the task data 230, the lottery log data 232, the salary data 234, the crowdworker data 236, the probability data 238, and the GUI data 240 are stored in the database server 104.

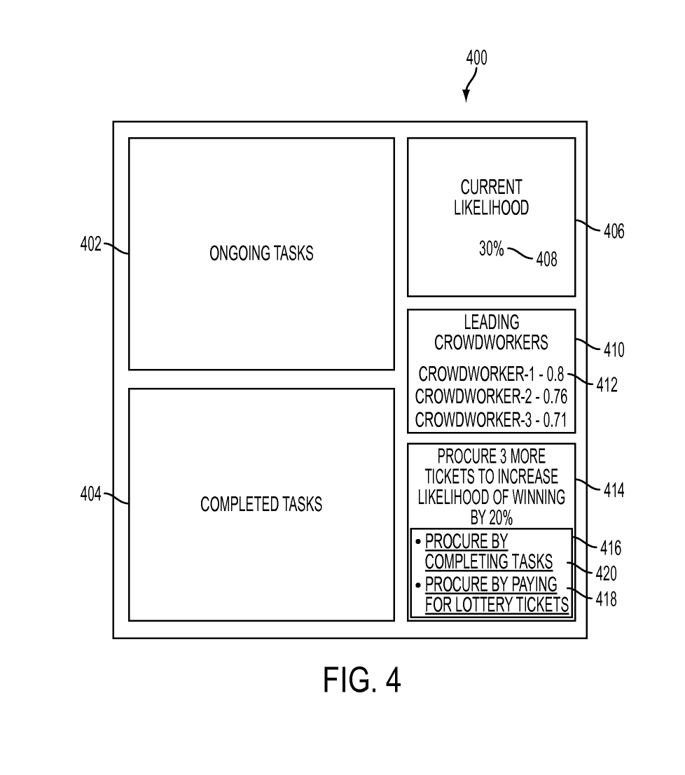

In an embodiment, the user interface manager 216 extracts data from GUI data 240 to generate the API. The communication manager 218 transmits the API to the computing device 108. The user interface manager 216 receives the user input through the API. In an embodiment, the user input may be intended for accessing the task received from the crowdsourcing platform. Further, the user input may be intended for submission of the final work product to the crowdsourcing platform. In the scenario where the system 200 is implemented on the computing device 108, the user interface manager 216 utilizes the display 208 to display the API. Further, the user interface manager 216 receives the user input through the input device 206. In an embodiment, the user interface manager 216 includes one or more drivers to operate the input device 206. The API is described later in conjunction with FIG. 4.

The communication manager 218 transmits the API to the computing device 108 through the transceiver 204. In an embodiment, the communication manager 218 receives the user input through the API. The communication manager 218 includes various protocol stacks such as, but not limited to, TCP/IP, UDP, and 2G, 3G, or 4G communication protocols. The communication manager 218 transmits and receives the messages/data (e.g., images) through the transceiver 204 in accordance with such protocol stacks.

The task manager 220 allocates the one or more tasks to the one or more crowdworkers associated with the system 200. In an embodiment, the task manager 220 publishes the allocation of the one or more tasks through the API. Further, the task manager 220 receives the final work product for the allocated tasks from the one or more crowdworkers. In an embodiment, the task manager 220 validates the final work product for quality checks. Further, the task manager 220 stores the information associated with the one or more tasks (i.e., allocation of the tasks, corresponding final work product, validation results) as the task data 230.

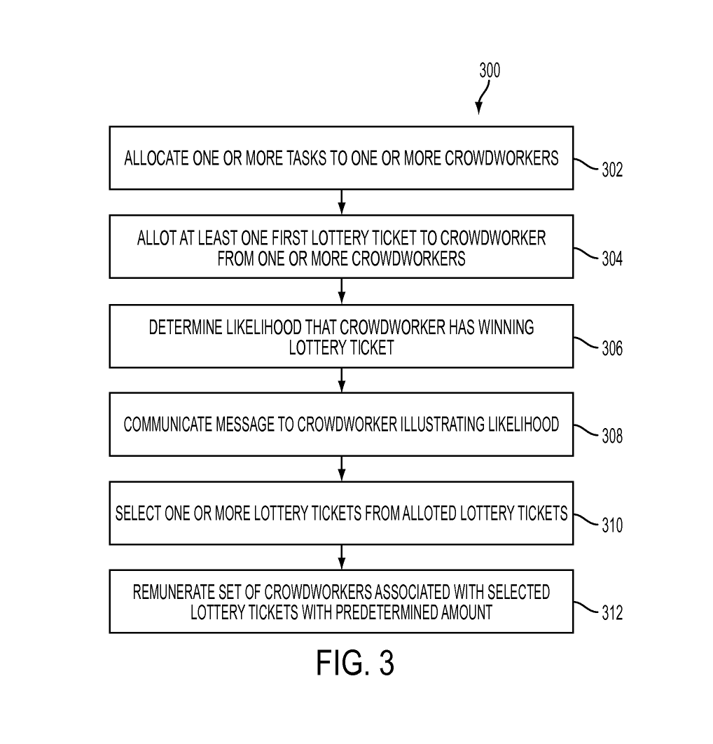

The lottery distribution manager 222 extracts a list of completed tasks from the task data 230. Further, lottery distribution manager 222 extracts a list of crowdworkers from the crowdworker data 236 corresponding to the tasks in the list of completed tasks. Thereafter, the lottery distribution manager 222 allots a lottery ticket to each crowdworker in the list of crowdworkers. In an embodiment, the lottery distribution manager 222 may allot a crowdworker in the list of crowdworkers more than one lottery tickets. In an embodiment, the lottery distribution manager 222 may utilize one or more querying languages to extract the list of crowdworkers and the list of completed tasks from the crowdworker data 236 and the task data 230. In an alternate embodiment, the lottery distribution manager 222 may utilize the one or more querying languages such as, but are not limited to, SQL, QUEL, and DMX to extract the list of crowdworkers and the list of completed tasks from the database server 104. The lottery distribution manager 222 maintains a log of the allotted lottery tickets. Further, the lottery distribution manager 222 stores the log as the lottery log data 232. The distribution of the lottery tickets is described later in conjunction with FIG. 3.

The lottery selection module 224 extracts information related to the allotted lottery tickets from the lottery log data 232. The lottery selection module 224 selects one or more lottery tickets from the allotted lottery tickets using one or more techniques, such as, a verifiable random function, a publically generated randomness, and a public random source. In an embodiment, the one or more lottery tickets are the winning tickets. The selection of the one or more lottery tickets is described later in conjunction with FIG. 3.

The remuneration manager 226 determines a set of crowdworkers associated with the one or more lottery tickets (selected by the lottery selection module 224). The remuneration manager 226 remunerates winnings (or winning amount) to the set of crowdworkers. In an embodiment, the remuneration manager 226 remunerates a predetermined pay to each crowdworker in the list of crowdworkers on the completion of the one or more tasks. In an embodiment, the remuneration manager 226 may utilize the one or more techniques such as wire transfer to remunerate the set of crowdworkers.

The probability determination module 228 determines likelihood of each crowdworker in the list of crowdworkers being remunerated based on the number of lottery tickets allotted to each crowdworker in the list of crowdworkers. The probability determination module 228 utilizes one or more techniques such as Bayes theorem and various probability distribution functions to determine the likelihood. The determination of the likelihood is described later in conjunction with FIG. 3.

FIG. 3 is a flowchart 300 illustrating a method for remunerating a crowdworker, in accordance with at least one embodiment. The flowchart 300 is described in conjunction with FIG. 1 and FIG. 2.

At step 302, the one or more tasks are allocated to the one or more crowdworkers. In an embodiment, the task manager 220 allocates the one or more tasks. The one or more crowdworkers receive the one or more tasks through the API being displayed on respective computing devices 108. In an embodiment, the one or more crowdworkers selects the one or more tasks through the API. In an alternate embodiment, the one or more tasks are allocated to the one or more crowdworkers based on various parameters such as, but are not limited to, skill set of the one or more crowdworkers, infrastructure available with the one or more crowdworkers, cost of the one or more crowdworkers, timelines and the like. The one or more crowdworkers may complete the one or more tasks. On the completion of the one or more tasks, the one or more crowdworkers submit a final work product to the crowdsourcing platform through the API. In an embodiment, on receiving the final work product, the task manager 220 may validate the final work product for quality checks. Additionally, the task manager 220 stores all the information related to the distribution of the one or more tasks, the reception of the final work product and the validation of the final work product as the task data 230.

At step 304, at least one first lottery ticket is allotted to a crowdworker from the one or more crowdworkers on the completion of the task. In an embodiment, the lottery distribution manager 222 allots the at least one first lottery ticket. Firstly, the lottery distribution manager 222 extracts a list of completed tasks from the task data 230. Further, the lottery distribution manager 222 determines the list of crowdworkers that have submitted the final work product for the one or more allocated tasks. Thereafter, the lottery distribution manager 222 allots the at least one first lottery ticket to the list of crowdworkers based on the number of tasks completed by each crowdworker in the list of crowdworkers.

In an alternate embodiment, a predetermined pay is remunerated to the crowdworker on the completion of the task. The crowdworker may utilize the pay to buy one or more second lottery tickets. In such a scenario, the user interface manager 216 presents an option to the crowdworker through the API to buy the lottery ticket. The crowdworker may choose to buy the one or more second lottery tickets based on his/her discretion.

In another embodiment, the crowdworker may receive both, the at least one first lottery ticket and the predetermined pay on the completion of the task. The crowdworker may buy the one or more second lottery tickets using the predetermined pay. Thus, the crowdworker may have the one or more second lottery tickets in addition to the at least one first lottery ticket.

For example, 50 tasks were distributed among 25 crowdworkers. Of the 25 crowdworkers, five crowdworkers declined to work on the allocated tasks. Thus, 20 crowdworkers completed the 50 tasks. On the completion of the each task from the 50 tasks, the respective crowdworker receives a lottery ticket. In addition to the lottery ticket, the respective crowdworker receives a predetermined pay. For instance, “crowdworker-1” completes nine tasks from the 50 tasks. Hence, the “crowdworker-1” will receive nine lottery tickets. Along with the nine lottery tickets, the “crowdworker-1” may receive the predetermined pay for each nine completed tasks. The “crowdworker-1” may utilize the predetermined pay to buy more lottery tickets. For instance, the “crowdworker-1” may utilize a portion of the predetermined pay to but two more lottery tickets. Thus, the “crowdworker-1” is in the possession of total 11 lottery tickets.

A person having ordinary skill in the art would understand that the scope of the disclosure is not limited to buying the lottery tickets from the predetermined pay. In an embodiment, the “crowdworker-1” may utilize other means such as, net-banking, credit card, and debit card to buy the lottery tickets.

At step 306, likelihood that a crowdworker from the list of crowdworker (that have completed the tasks) has the winning lottery ticket is determined. In an embodiment, the probability determination module 228 determines the likelihood. The probability determination module 228 determines a total number of lottery tickets (x) that have been allotted to the list of crowdworkers. Thereafter, the probability determination module 228 determines the number of lottery tickets (y) allotted to each crowdworker in the list of crowdworkers. Based on the total number of tickets allotted to the list of crowdworkers and the number of lottery tickets allotted to each crowdworker, the probability determination module 228 determines the likelihood. Further, the probability determination module 228 stores the likelihood as the probability data 238. In an embodiment, the probability determination module 228 utilizes following equation to compute the probability:

P(cᵢ)=1−^{x-y}_{z}ⁱC/_{z}^{x}C (1)

where,

P(cᵢ): Probability that at least one lottery ticket associated with the i^{th} crowdworker is selected;

x: Total number of lottery tickets that have been allotted to the list of crowdworkers;

yᵢ: Total number of lottery tickets allotted to the i^{th} crowdworker;

C: Combination or choose operator; and

z: Total number of lottery tickets to be selected as the winning tickets.

In an alternate embodiment, each of the allotted lottery tickets has predetermined weights. In an embodiment, the predetermined weights associated with a lottery ticket are determined based on the type of work completed by a crowdworker to obtain the lottery ticket. For example, a weight of a lottery ticket obtained by submitting a program code will be more in comparison to a weight associated with a lottery ticket obtained by completing a task of digitizing a document. In an embodiment, weights associated with a lottery ticket are deterministic of the likelihood. For example, a “crowdworker-1” has five lottery tickets that have weights more than weights of 10 lottery tickets associated with a “crowdworker-2”. The likelihood that the “crowdworker-1” wins the lottery may be higher than the likelihood of the “crowdworker-2” as the weights of the lottery tickets associated with the “crowdworker-1” is more than the weights of the lottery tickets associated with the“crowdworker-2”.

At step 308, a message is communicated to each crowdworker in the list of crowdworker illustrating the likelihood computed in the step 306. In an embodiment, the user interface manager 216 displays the message through the API. In an embodiment, the message may further illustrate a percentage change in the likelihood if the crowdworker procures a predetermined number of lottery tickets. In an embodiment, the crowdworker may buy the predetermined number of lottery tickets to have a higher probability to win. For example, the message may illustrate “procure 3 more lottery tickets to increase your chance of winning by 12%”. In an alternate embodiment, the crowdworker may complete more tasks to procure the predetermined number of lottery tickets.

In another embodiment, the message may include names of the crowdworkers from the list of crowdworkers that are most likely to win the lottery. In an embodiment, the user interface manager 216 extracts the likelihood data for each crowdworker in the list of crowdworkers. Thereafter, the user interface manager 216 determines crowdworkers having maximum likelihood of winning. The user interface manager 216 displays the names of the crowdworkers that are most likely to win to each crowdworker in the list of crowdworkers.

In an embodiment, the likelihood being displayed on the API to the crowdworker changes in real time. In such a scenario, steps 306 and 308 are repeated with the completion of each task from the one or more tasks. For example, the likelihood of a “crowdworker-1” to win the lottery is 0.7 and that of a “crowdworker-2” is 0.3. Let the total number of lottery tickets procured by the “crowdworker-1” and the “crowdworker-2” is five and three, respectively. The “crowdworker-2” has completed two more tasks from the one or more tasks to procure two more tickets. Steps 306 and 308 are repeated on the completion of the two tasks to display the message to display updated likelihood to both the “crowdworker-1” and the “crowdworker-2” (e.g., 0.5 and 0.5, respectively).

At step 310, the one or more lottery tickets are selected from the allotted lottery tickets (step 304) using the one or more techniques. In an embodiment, the lottery selection module 224 selects the one or more lottery tickets as the winning tickets. In an embodiment, the one or more techniques may include, but not limited to, the public random source, the publicly generated randomness, and the verifiable random functions.

For example, the public random source is selected for determining the one or more lottery tickets. In such a scenario, the lottery selection module 224 utilizes a random number drawn on a popular and trusted source such as “Fantasy Five” and the like. Let the number drawn in “Fantasy Five” be C. In an embodiment, the lottery selection module 224 utilizes following equation to determine a lottery ticket number:

Lottery ticket number=Mod(C/T) (2)

where,

C: Number drawn in the popular game show; and

T: Total number of tasks in the list of completed tasks.

The lottery selection module 224 selects the lottery ticket pertaining to the lottery ticket number (determined by equation 2) as the one or more selected lottery tickets.

In another example, the publicly generated randomness is selected for the determining the one or more lottery tickets. In such a scenario, the lottery selection module 224 may utilize the lottery ticket ID and the number of completed tasks to determine the one or more lottery tickets. For example, the crowdworker receives a number t, on the completion of the i^{th} task. The lottery selection module 224 utilizes following equation to determine a lottery ticket number:

Lottery ticket number=Mod_{T}(Σᵢ₌₁^{T}tᵢ) (3)

The lottery selection module 224 selects the lottery ticket pertaining to the lottery ticket number (determined by equation 3) as the one or more selected lottery tickets.

In an embodiment, the one or more lottery tickets are selected from the allotted lottery tickets post a predetermined time period. In an embodiment, the one or more lottery tickets are selected on a weekly basis. In another embodiment, the one or more lottery tickets are selected after completion of all tasks. In yet another embodiment, the one or more lottery tickets may be selected on completion of each of the one or more tasks.

At step 312, a set of crowdworkers associated with the one or more lottery tickets (selected in step 310) are remunerated with winnings. In an embodiment, the remuneration manager 226 remunerates the winnings. For instance, the winnings are the winning amount of money. In an embodiment, the winnings are remunerated to each crowdworker in the set of crowdworkers. In an alternate embodiment, the winnings are distributed among each of the set of crowdworkers.

In an alternate embodiment, the winnings to be remunerated by the remuneration manager 226 vary with each completed task. For example, the winning amount is 1000 USD. With completion of a task from the one or more tasks, 1 USD is added to the winning amount. For instance, if 100 tasks from the one or more tasks have been completed, the total winning amount will increase to 1100 USD.

Remunerating the one or more crowdworker with the one or more lottery tickets is a cost effective for the crowdsourcing platforms and the enterprise that have requested for the one or more tasks. In an embodiment, following equation is used for computing cost to enterprise:

Cost to enterprise=Σᵢ(pᵢdᵢ−e) (4)

where,

pᵢ: Proabability that i^{th} lottery ticket is selected;

dᵢ: Amount of money for winning ticket; and

e: Cost paid by crowdworker to buy the lottery ticket.

A person having ordinary skill in the art would understand that equations 1 to 4 have been mentioned for illustrative purposes and the scope of disclosure should not be limited to equations 1 to 4 in the current form. In an embodiment, equations 1 to 4 can vary with the application.

FIG. 4 is an example API 400 displayed to the crowdworker, in accordance with at least one embodiment. The API 400 is described in conjunction with FIG. 1, FIG. 2, and FIG. 3.

The API 400 includes a portion 402 that displays a list of tasks allocated to a crowdworker. A portion 404 displays the list of tasks completed by the crowdworker. A portion 406 displays the current likelihood of the crowdworker to win the lottery (as determined in step 306). For example, the portion 406 displays value 30% (depicted by 408); the crowdworker has 30% chance of winning the lottery. A portion 410 displays a list of other crowdworkers that have the maximum chance of winning the lottery. For example, “crowdworker-1” has a 0.8 likelihood of winning the lottery (depicted by 412). A portion 414 displays a message about number of tickets more to procure in order to increase the likelihood of winning. For example, the message displays “Procure 3 more tickets to increase likelihood of winning by 20%”. A portion 416 provides an option to procure lottery tickets by paying (depicted by 418) or to procure the lottery tickets by completing the tasks mentioned in the portion 404 (depicted by 420).

In an alternate embodiment, the crowdsourcing platform does not allot the lottery ticket to the one or more crowdworkers on completion of the respective tasks. In this case, the crowdsourcing platform maintains a log of the total number of tasks completed by each of the one or more crowdworkers. Probability that a crowdworker from the one or more crowdworkers wins the lottery is determined based on the total number of tasks completed by the crowdworker. In an embodiment, more the number of tasks completed by the crowdworker more are the probability that the crowdworker wins the lottery. The crowdsourcing platform selects a set of task from the one or more tasks. The crowdworkers that have worked on the set of tasks are declared as the winners.

The disclosed embodiments encompass numerous advantages. The crowdworkers are allotted lottery tickets on completion of the respective tasks. More the number of tasks completed by a crowdworker more lottery tickets will be allotted to the crowdworker. Further, more the lottery tickets, greater will be the probability of winning the jackpot amount (or winning amount). Thus, the thought of winning the predetermined amount might motivate the crowdworker to complete more tasks in order to get maximum number of lottery tickets.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in all operating systems and platforms including, but not limited to, ‘Unix’, DOS', ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for paying a crowdworker have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method implementable on a computing device for remunerating one or more crowdworkers, the method comprising:
allotting at least one crowdworker from the one or more crowdworkers with a first lottery ticket from a set of lottery tickets on completion of a task allocated to the at least one crowdworker;
selecting one or more lottery tickets from the set of lottery tickets by utilizing one or more techniques; and
remunerating winnings to each of a set of crowdworkers from the one or more crowdworkers associated with the one or more selected lottery tickets.

2. The method of claim 1 further comprising remunerating a predetermined pay to the at least one crowdworker on completion of the task.

3. The method of claim 2 further comprising providing an option to the at least one crowdworker to buy a second lottery ticket from the predetermined pay.

4. The method of claim 1, wherein a number of lottery tickets allotted to the at least one crowdworker is proportional to a number of tasks completed by the at least one crowdworker.

5. The method of claim 4 further comprising determining likelihood for the at least one crowdworker of being remunerated based on the number of lottery tickets allotted to the at least one crowdworker.

6. The method of claim 5 further comprising communicating a message illustrating the likelihood to the at least one crowdworker.

7. The method of claim 1 further comprising displaying a list of crowdworkers from the one or more crowdworkers that is most likely to be remunerated.

8. The method of claim 1, wherein the one or more techniques comprise at least one of a verifiable random function, a publically generated randomness, or a public random source.

9. A crowdsourcing server for remunerating one or more crowdworkers, the crowdsourcing server comprises:
a lottery distribution manager configured to allot at least one crowdworker from the one or more crowdworkers with a first lottery ticket from a set of lottery tickets on completion of a task allocated to the at least one crowdworker;
a lottery selection module configured to select one or more lottery tickets from the set of lottery tickets by utilizing one or more techniques; and
a remuneration manager configured to remunerate winnings to each of a set of crowdworkers from the one or more crowdworkers associated with the one or more selected lottery tickets.

10. The crowdsourcing server of claim 9, wherein the remuneration manager is further configured to remunerate a predetermined pay to the at least one crowdworker on completion of the task.

11. The crowdsourcing server of claim 9 further comprising a probability determination module configured to determine likelihood of the at least one crowdworker being remunerated based on a number of lottery tickets allotted to the at least one crowdworker, wherein the number of lottery tickets allotted to the at least one crowdworker is proportional to a number of tasks completed by the at least one crowdworker.

12. The crowdsourcing server of claim 11 further comprising a user interface manager configured to display a message to the at least one crowdworker illustrating the likelihood.

13. The crowdsourcing server of claim 12, wherein the user interface manager is configured to display a list of crowdworkers from the one or more crowdworkers that is most likely to be remunerated.

14. The crowdsourcing server of claim 9 further comprising a task manager configured to allocate one or more tasks to the at least one crowdworker.

15. A computer program product for remunerating one or more crowdworkers, the computer program product comprising a set of instructions executable by a processor, the set of instructions comprising:
a program instruction means for allotting at least one crowdworker from the one or more crowdworkers with at least one of a first lottery ticket from a set of lottery tickets on completion of a task allocated to the at least one crowdworker;
a program instruction means for selecting one or more lottery tickets from the set of lottery tickets by utilizing one or more techniques; and
a program instruction means for remunerating winnings to each of a set of crowdworkers from the one or more crowdworkers associated with the one or more selected lottery tickets.

16. The computer program product of claim 15 further comprising a program instruction means for remunerating a predetermined pay to the at least one crowdworker on completion of the task.

17. The computer program product of claim 16 further comprising a program instruction means for providing an option to the at least one crowdworker to buy a second lottery ticket from the predetermined pay.

18. The computer program product of claim 15, wherein a number of lottery tickets allotted to the at least one crowdworker is proportional to a number of tasks completed by the at least one crowdworker.

19. The computer program product of claim 18 further comprising a program instruction means for determining likelihood for the at least one crowdworker of being remunerated based on the number of lottery tickets allotted to the at least one crowdworker.

20. The computer program product of claim 19 further comprising a program instruction means for displaying a message to the at least one crowdworker illustrating the likelihood.
